(19) United States
(12) Patent Application Publication
(10) Pub. No.: US 2026/0178108 A1
(43) Pub. Date: Jun. 25, 2026

(54) DELEGATING WORK AMONG COMPUTE UNITS

(71) Applicant: Google LLC, Mountain View, CA (US)

(72) Inventor: Russell William Myers, Marietta, GA (US)

(21) Appl. No.: 18/990,474

(22) Filed: Dec. 20, 2024

(51) Int. Cl. G06F 1/3293; G06F 9/48

(52) U.S. Cl. CPC G06F 1/3293; G06F 9/4856

(57) ABSTRACT

An example method includes receiving, by a lower-power compute unit of a wearable device, a job. The method also includes determining, by the lower-power compute unit, if the job is associated with a first class of jobs, a second class of jobs, or a third class of jobs. The method further includes, responsive to determining that the job is associated with the first class of jobs, performing, by the lower-power compute unit, the job. The method additionally includes, responsive to determining that the job is associated with the second class of jobs, performing, by a higher-power compute unit of the wearable device, the job. The method also includes, responsive to determining that the job is associated with the third class of jobs, transmitting, by the lower-power compute unit, the job to a companion device; and receiving, from the companion device, a result, the result based on performing the job.

### BACKGROUND

Computing devices, such as wearable devices and mobile devices, implement a primary processor to perform jobs necessary for device functionality. The primary processor may default to a low-power state (e.g., sleep or idle state) to conserve system resources, only performing jobs following scheduled kernel wake-up events.

### SUMMARY

In general, techniques of this disclosure are directed to delegating work to a separate processor. An example wearable device includes a primary processor and a lower-power compute unit. The primary processor may be an application processor (AP), and the lower-power compute unit may be a microcontroller unit (MCU). The lower-power compute unit may receive a job. After receiving the job, the lower-power compute unit determines a class of the job. In some implementations, the job is associated with a pre-determined class identifier. For instance, an API may indicate that the job is associated with a first class of jobs, e.g., jobs that should be executed by the lower-power compute unit. In determining an appropriate class for the job, the lower-power compute unit may assess factors associated with the job or the wearable device. Some factors may be associated with the job, such as a time complexity, space complexity, input size, predicted power consumption, and specialized operation specification. Other factors may be associated with the wearable device, such as battery state, thermal state, utilization state, or hardware topology of the wearable device. The lower-power compute unit may use a wholistic approach to assess the factors, e.g., assessing predicted power consumption in light of a battery state.

If the job is associated with a first class of jobs, the lower-power compute unit performs the job via a wireless network connection of the wearable device. For example, a job for updating weather information on a display may include executing a web request via an antenna of the wearable device and changing the display to reflect the received information. If the job is associated with a second class of jobs, the primary processor may perform the job via the wireless network connection. For instance, the primary processor may execute a web request via the antenna and change the display to reflect the received information. If the job is associated with a third class of jobs, the lower-power compute unit may transmit the job to a companion device, such as a mobile phone. The companion device may then return a result to the wearable device after performing the job.

In one example, the disclosure is directed toward a method that includes receiving, by a lower-power compute unit of a wearable device, a job. The method further includes determining, by the lower-power compute unit, if the job is associated with a first class of jobs, a second class of jobs, or a third class of jobs. The method also includes responsive to determining that the job is associated with the first class of jobs, performing, by the lower-power compute unit, the job. The method additionally includes responsive to determining that the job is associated with the second class of jobs, performing, by a higher-power compute unit of the wearable device, the job. The method further includes responsive to determining that the job is associated with the third class of jobs: transmitting, by the lower-power compute unit, the job to a companion device; and receiving, from the companion device, a result, the result based on performing the job.

In another example, the disclosure is directed toward a computing system comprising one or more processors, and one or more storage devices that store instructions. The instructions, when executed by the one or more processors, cause the one or more processors to receive a job. The instructions further cause the one or more processors to determine if the job is associated with a first class of jobs, a second class of jobs, or a third class of jobs. The instructions also cause the one or more processors to, responsive to determining that the job is associated with the first class of jobs, perform, by a lower-power compute unit of the one or more processors, the job. The instructions additionally cause the one or more processors to, responsive to determining that the job is associated with the second class of jobs, perform, by a higher-power compute unit of the one or more processors, the job. The instructions also cause the one or more processors to responsive to determining that the job is associated with the third class of jobs: transmit the job to a companion device; and receive a result, the result based on performing the job.

In another example, the disclosure is directed toward a non-transitory computer-readable storage medium encoded with instructions that, when executed by one or more processors, cause one or more processors to receive a job. The instructions further cause the one or more processors to determine if the job is associated with a first class of jobs, a second class of jobs, or a third class of jobs. The instructions also cause the one or more processors to, responsive to determining that the job is associated with the first class of jobs, perform, by a lower-power compute unit of the one or more processors, the job. The instructions additionally cause the one or more processors to, responsive to determining that the job is associated with the second class of jobs, perform, by a higher-power compute unit of the one or more processors, the job. The instructions also cause the one or more processors to responsive to determining that the job is associated with the third class of jobs: transmit the job to a companion device; and transmit a result, the result based on performing the job.

In another example, the disclosure is directed toward a computer program product for delegating work among compute units. The computer program product comprises one or more instructions that, when executed by at least one processor, cause the at least one processor to receive a job. The one or more instructions further cause the at least one processor to determine if the job is associated with a first class of jobs, a second class of jobs, or a third class of jobs. The one or more instructions also cause the at least one processor to, responsive to determining that the job is associated with the first class of jobs, perform, by a lower-power compute unit of the one or more processors, the job. The one or more instructions additionally cause the at least one processor to responsive to determining that the job is associated with the second class of jobs, perform, by a higher-power compute unit of the one or more processors, the job. The one or more instructions also cause the at least one processor to responsive to determining that the job is associated with the third class of jobs: transmit the job to a companion device; and receive a result, the result based on performing the job.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating an example computing device for delegating work, in accordance with one or more techniques of this disclosure.

FIG. 2 is a conceptual diagram illustrating another example computing system for delegating work, in accordance with one or more techniques of this disclosure.

FIG. 3 is a conceptual diagram illustrating example communication techniques via various application programming interfaces (APIs), in accordance with one or more techniques of this disclosure.

FIG. 4 is a flowchart illustrating an example operation for delegating work among compute units, in accordance with one or more techniques of this disclosure.

### DETAILED DESCRIPTION

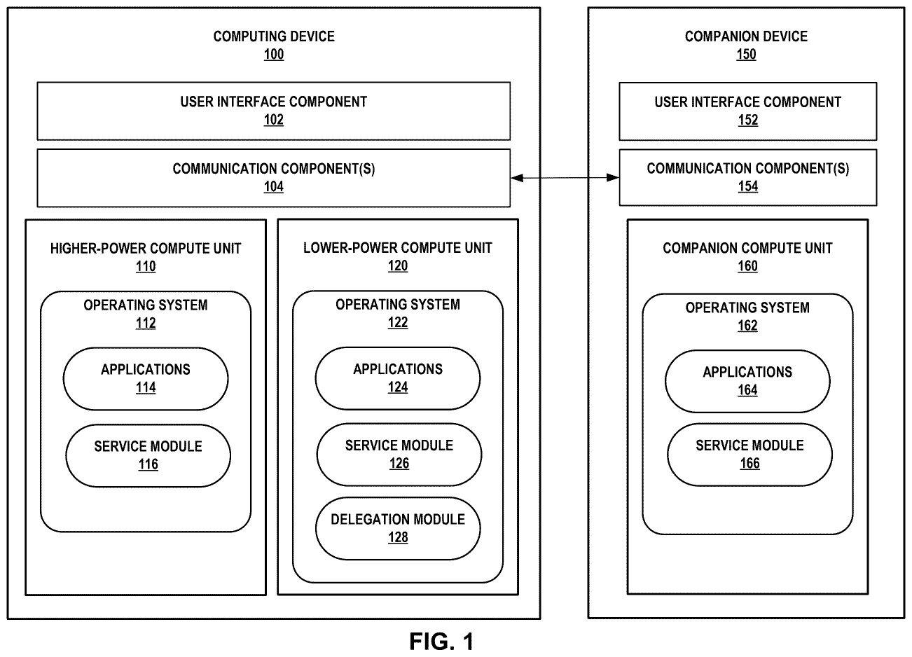

FIG. 1 is a conceptual diagram illustrating an example computing device for delegating work, in accordance with one or more techniques of this disclosure. In the example of FIG. 1, computing device 100 may be an individual mobile or non-mobile computing device. Examples of computing device 100 include a mobile phone, a tablet computer, a laptop computer, a desktop computer, a server, a mainframe, a set-top box, a television, a wearable device (e.g., a computerized watch, computerized eyewear, computerized headphones, computerized gloves, computerized ring, etc.), a home automation device or system (e.g., an intelligent thermostat or home assistant device), a gaming system, a media player, an e-book reader, a mobile television platform, an augmented reality device, a virtual reality device, a mixed reality device, an automobile navigation or infotainment system, or any other type of mobile, non-mobile, wearable device, and non-wearable device configured to delegate work in accordance with techniques of this disclosure. Computing device 100 may implement various compute resources, such as processors, memory, data storage, data buses, input/output controllers, network interfaces, accelerators (e.g., graphics accelerators), and power management units.

Computing device 100 includes user interface component (UIC) 102. UIC 102 may function as an input and/or output device for computing device 100 and may be implemented using various technologies. For instance, UIC 102 may function as an input device using presence-sensitive input screens, microphone technologies, infrared sensor technologies, or other input device technology for use in receiving user input. UIC 102 may function as an output device configured to present output to a user using any one or more display devices, speaker technologies, haptic feedback technologies, or other output device technology for use in outputting information to a user.

One or more communication components 104 of computing device 100 may communicate with external devices via one or more wired and/or wireless networks by transmitting and/or receiving network signals on the one or more networks. Examples of communication components 104 include a network interface card (e.g., an Ethernet card), an optical transceiver, a radio frequency transceiver, a global positioning system (GPS) receiver, or any other type of device that can send and/or receive information. Other examples of communication components 104 may include short wave radios, cellular data radios, wireless network radios, as well as universal serial bus (USB) controllers. Communication components 104 may send and receive information from communication components 154 of companion device 150.

Computing device 100 includes higher-power compute unit 110. Higher-power compute unit 110 may be a primary processor and/or computing system configured to perform resource-intensive tasks via a general-purpose instruction set. For instance, higher-power compute unit 110 may be an application processor (AP), central processing unit (CPU), graphics processing unit (GPU), or any combination thereof. Higher-power compute unit 110 may include multiple cores and may support multiple threads, and may perform techniques such as parallel processing, graphics rendering, and multimedia processing.

In some implementations, higher-power compute unit 110 may include compute resources such as memory, data storage, and a multimedia encoder/decoder. For instance, higher-power compute unit 110 may be a system-on-chip (SOC) including an AP, memory, and a memory encoder. Further, higher-power compute unit 110 may utilize compute resources of computing device 100. For example, higher-power compute unit 110 may implement memory and data storage of computing device 100 to perform operations. Higher-power compute unit 110 may offer platform-level or system-level services, such as location services, sensor services, network services, power management services, and file system services.

Higher-power compute unit 110 executes operating system (OS) 112, OS 112 including applications 114 and service module 116. OS 112 and applications 114 may perform operations described herein using software, hardware, firmware, or a mixture of hardware, software, and firmware residing in and/or executing at computing device 100 or higher-power compute unit 110. In some implementations, higher-power compute unit 110 may execute OS 112 and applications 114 as virtual machines executing on underlying hardware, as one or more services of an operating system or computing platform, and/or as one or more executable programs at an application layer of higher-power compute unit 110.

OS 112 manages hardware resources and provides a platform for software execution at higher-power compute unit 110. OS 112 may perform scheduling algorithms (e.g., round-robin and multilevel queues), allocate memory via virtual memory management and paging mechanisms, and facilitate interprocess communication (IPC) via message queues, pipes, and shared memory. OS 112 may implement preemptive multitasking, real-time scheduling for deterministic latency, and dynamic power management to improve performance and power consumption of higher-power compute unit 110.

Applications 114 may be first-party, second-party, or third-party applications of OS 112. Applications 114 may extend software functionality of higher-power compute unit 110, where applications 114 may execute within an execution environment presented by OS 112. Applications 114 may, as a few examples, provide gaming services (e.g., video games), email services, web browsing services, texting and/or chat services, web conferencing services, video conferencing services, music services (including streaming music services), video services (including video streaming services), navigation services, weather services, word processing services, spreadsheet services, slide and/or presentation services, assistant services, text entry services, network access services, or any other application service.

Service module 116 may perform jobs via services offered by applications 114, OS 112, or higher-power compute unit 110. A job may be any task or unit of work performed by a service, and may represent a specific instance of the service's operation. Additionally, or alternatively, a job may be all or part of a task that is executed by a compute unit. For instance, a job may include retrieving weather data (e.g., temperature, humidity, forecast, etc.) from an online weather application programming interface (API) and using the received data to update a display or make decisions based on environmental conditions. Jobs may also be more granular. For example, a job may be a simple web request, where the simple web request is part of a larger job. Service module 116 may receive a job from a component of computing device 100, such as higher-power compute unit 110 or delegation module 128, and may transmit results to a component based on performing the service. For example, service module 116 may receive a job for performing a scheduled data backup for a dataset. Service module 116 may implement a data backup service offered by applications 114 or higher-power compute unit 110 to perform the data backup at a data storage unit of computing device 100. During the data backup, service module 116 may transmit progress indications to an application of applications 114.

Computing device 100 also includes lower-power compute unit 120. Lower-power compute unit 120 may be a specialized processor and/or computing system configured to perform tasks that are less resource-intensive than those performed by higher-power compute unit 110. For instance, lower-power compute unit 120 may be a microcontroller unit (MCU), sensor hub, digital signal processor (DSP), neural processing unit (NPU), image signal processor (ISP), or any combination thereof. Additionally, or alternatively, lower-power compute unit 120 may be a subset of a primary processor. For instance, lower-power compute unit 120 may be an always-on core of a multi-core processor. Lower-power compute unit 120 may support a specialized instruction set and may perform techniques such as image processing, lightweight control logic, and background processing.

Lower-power compute unit 120 may be less computationally capable than higher-power compute unit 110. For example, lower-power compute unit 120 may have a lower clock speed, a decreased core count, reduced instruction set capabilities, a smaller cache size, and/or less memory bandwidth than higher-power compute unit 110. However, lower-power compute unit 120 generally consumes less power than higher-power compute unit 110. For instance, higher-power compute unit 110 consumes more power to complete a task than lower-power compute unit 120 consumes for the same task. To conserve power, computing device 100 may perform operations via lower-power compute unit 120 while higher-power compute unit 110 remains in a sleep state or idle state. Higher-power compute unit 110 may wake to perform tasks according to a schedule or in response receiving an unscheduled wake event.

In some implementations, lower-power compute unit 120 may include compute resources such as memory, data storage, and input/output structures. For instance, lower-power compute unit 120 unit may be an SOC including a microcontroller and memory. In some implementations, lower-power compute unit 120 may be included in an SOC, the SOC also including higher-power compute unit 110 and/or other components of computing device 100. Further, lower-power compute unit 120 may utilize compute resources of computing device 100. For example, lower-power compute unit 120 may implement memory and data storage of computing device 100 to perform operations. Lower-power compute unit 120 may offer platform-level or system-level services, such as location services, sensor services, network services, power management services, and file system services.

Lower-power compute unit 120 executes OS 122, OS 122 including applications 124, service module 126, and delegation module 128. OS 122, applications 124, and delegation module 128 may perform operations described herein using software, hardware, firmware, or a mixture of hardware, software, and firmware residing in and/or executing at computing device 100 or lower-power compute unit 120. In some implementations, lower-power compute unit 120 may execute OS 122 and applications 124 as virtual machines executing on underlying hardware, as one or more services of an operating system or computing platform, and/or as one or more executable programs at an application layer of lower-power compute unit 120.

OS 122 manages hardware resources and provides a platform for software execution at lower-power compute unit 120. OS 122 may perform scheduling algorithms (e.g., round-robin and multilevel queues), allocate memory via virtual memory management and paging mechanisms, and facilitate IPC via message queues, pipes, and shared memory. OS 122 may implement preemptive multitasking, real-time scheduling for deterministic latency, and dynamic power management to improve performance and power consumption of lower-power compute unit 120.

Applications 124 may be first-party, second-party, or third-party applications of OS 122. Applications 124 may extend software functionality of lower-power compute unit 120, where applications 124 may execute within an execution environment presented by OS 122. Applications 124 may, as a few examples, provide gaming services (e.g., video games), email services, web browsing services, texting and/or chat services, web conferencing services, video conferencing services, music services (including streaming music services), video services (including video streaming services), navigation services, weather services, word processing services, spreadsheet services, slide and/or presentation services, assistant services, text entry services, network access services, or any other application service. Some applications of applications 124 may also be applications of applications 114. For instance, a fitness tracking application may operate on both lower-power compute unit 120 and higher-power compute unit 110.

Service module 126 may perform jobs via services offered by applications 124, OS 122, or lower-power compute unit 120. Service module 126 may receive a job from a component of computing device 100, such as lower-power compute unit 120 or delegation module 128, and may transmit results to a component based on performing the service. For example, service module 126 may receive a job for determining a location of computing device 100. Service module 126 may implement a position system component of computing device 100 to determine the location and may then transmit the location to a component of computing device 100.

Delegation module 128 may delegate jobs to various components of computing device 100 and/or companion device 150, such as service module 116, service module 126, and/or service module 166. For instance, delegation module 128 may receive a job from a component of computing device 100. Responsive to receiving the job, delegation module 128 may classify the job to determine a destination for the job. Delegation module 128 may then transmit all or part of the job to the destination. For instance, delegation module 128 may transmit all or part of the job to higher-power compute unit 110. Additionally, or alternatively, delegation module 128 may transmit all or part of the job to companion compute unit 160 via communication components 104.

Companion device 150 may be an individual mobile or non-mobile computing device. Examples of companion device 150 include a mobile phone, a tablet computer, a laptop computer, a desktop computer, a server, a mainframe, a set-top box, a television, a wearable device (e.g., a computerized watch, computerized eyewear, computerized headphones, computerized gloves, computerized ring, etc.), a home automation device or system (e.g., an intelligent thermostat or home assistant device), a gaming system, a media player, an e-book reader, a mobile television platform, an augmented reality device, a virtual reality device, a mixed reality device, an automobile navigation or infotainment system, or any other type of mobile, non-mobile, wearable, and non-wearable computing device configured to delegate work in accordance with techniques of this disclosure. Companion device 150 may implement various compute resources, such as processors, memory, data storage, data buses, input/output controllers, network interfaces, accelerators (e.g., graphics accelerators), and power management units.

Companion device 150 includes a UIC 152. UIC 152 may function as an input and/or output device for companion device 150 and may be implemented using various technologies. For instance, UIC 152 may function as an input device using presence-sensitive input screens, microphone technologies, infrared sensor technologies, or other input device technology for use in receiving user input. UIC 152 may function as an output device configured to present output to a user using any one or more display devices, speaker technologies, haptic feedback technologies, or other output device technology for use in outputting information to a user.

One or more communication components 154 of companion device 150 may communicate with external devices via one or more wired and/or wireless networks by transmitting and/or receiving network signals on the one or more networks. Examples of communication components 154 include a network interface card (e.g., an Ethernet card), an optical transceiver, a radio frequency transceiver, a GPS receiver, or any other type of device that can send and/or receive information. Other examples of communication components 154 may include short wave radios, cellular data radios, wireless network radios, as well as USB controllers. Communication components 154 may send and receive information from communication components 104 of computing device 100.

Companion device 150 includes companion compute unit 160. Companion compute unit 160 may be a processor or computing system configured to perform tasks. For instance, companion compute unit 160 may be an AP, CPU, GPU, MCU, DSP, ISP, or any combination thereof. In some implementations, companion compute unit 160 may include other compute resources. For instance, companion compute unit 160 may be a SOC including an CPU, memory, and a DSP. Further, companion compute unit 160 may utilize compute resources of companion device 150. For example, companion compute unit 160 may implement memory and data storage of companion device 150 to perform operations. Companion compute unit 160 may offer platform-level or system-level services, such as location services, sensor services, network services, power management services, and file system services.

Companion compute unit 160 executes OS 162, OS 162 including applications 164 and service module 166. OS 162 and applications 164 may perform operations described herein using software, hardware, firmware, or a mixture of hardware, software, and firmware residing in and/or executing at companion device 150 or companion compute unit 160. In some implementations, companion compute unit 160 may execute OS 162 and applications 164 as virtual machines executing on underlying hardware, as one or more services of an operating system or computing platform, and/or as one or more executable programs at an application layer of companion compute unit 160.

OS 162 manages hardware resources and provides a platform for software execution at companion compute unit 160. OS 162 may perform scheduling algorithms (e.g., round-robin and multilevel queues), allocate memory via virtual memory management and paging mechanisms, and facilitate IPC via message queues, pipes, and shared memory. OS 162 may implement preemptive multitasking, real-time scheduling for deterministic latency, and dynamic power management to improve performance and power consumption of companion compute unit 160.

Applications 164 may be first-party, second-party, or third-party applications of OS 162. Applications 164 may extend software functionality of companion compute unit 160, where applications 164 may execute within an execution environment presented by OS 162. Applications 164 may, as a few examples, provide gaming services (e.g., video games), email services, web browsing services, texting and/or chat services, web conferencing services, video conferencing services, music services (including streaming music services), video services (including video streaming services), navigation services, weather services, word processing services, spreadsheet services, slide and/or presentation services, assistant services, text entry services, network access services, or any other application service.

Service module 166 may perform jobs via services offered by applications 164, OS 162, or companion compute unit 160. Service module 166 may receive a job from a component of companion device 150, such as companion compute unit 160 or delegation module 128, and may transmit results to a component based on performing the service. For example, service module 166 may receive, from delegation module 128, a job for retrieving stock market information. Service module 166 may implement a web-access service from companion compute unit 160, operating system 162, or applications 164 to retrieve the stock market information, and then may transmit the stock market information to computing device 100 via communication components 154.

As discussed, delegation module 128 may delegate jobs to various components of computing device 100 and/or companion device 150. In some implementations, delegation module 128 may receive a job from a component of computing device 100. For example, computing device 100 may be a wearable device such as a watch. Higher-power compute unit 110 may be an AP implementing a first operating system and lower-power compute unit 120 may be an MCU implementing a second operating system. Delegation module 128 may implement an API for delegating work via lower-power compute unit 120. The API for delegating work may be configured to receive function calls from one or more components of computing device 100.

Each function call may include one or more parameters associated with work to be completed. For instance, the parameters may indicate one or more jobs to be completed, a priority for the job(s), destination instructions, and wake instructions. Delegation module 128 may implement the priority for the job(s) to determine a compute unit to perform the job and whether to wake the compute unit. For example, delegation module 128 may be more likely to delegate high-priority jobs to a more powerful compute unit such as an AP, and delegation module 128 may be more likely to interrupt a sleep cycle of the AP to have the AP perform the high-priority job.

The destination instructions may indicate a compute unit to perform the job(s). For example, a function call may include a job for performing a web request and may specify that companion compute unit 160 is to perform the web request. Delegation module 128 may delegate the job to companion compute unit 160 according to the destination instructions, despite other factors (e.g., companion device 150 being in a low-battery state). Similarly, a wake instruction parameter may specify whether to wake a destination compute unit to perform the job(s).

In some implementations, delegation module 128 may divide a job received via a function call into two or more jobs. For instance, delegation module 128 may receive a job for tracking and displaying fitness activity on a wearable device. Delegation module 128 may divide the job into: collecting sensor data, processing health metrics based on the sensor data, uploading the health metrics to a cloud server, and displaying the health metrics in a graphical user interface (GUI) of the wearable device. Delegation module 128 may then delegate each of the jobs to various compute units of computing device 100 or companion device 150 based on a class associated with each job.

After receiving a job, delegation module 128 may determine if the job is associated with a first class of jobs, a second class of jobs, or a third class of jobs. In some implementations, first-class jobs may be associated with lower-power compute unit 120. Second-class jobs may be associated with higher-power compute unit 110, and third-class jobs may be associated with companion compute unit 160. Delegation module 128 may implement one or more techniques to determine a class for the job.

Delegation module 128 may determine a class for the job based on destination instructions associated with the job. As discussed, a function call to delegation module 128 may include one or more job(s) and parameters associated with the job(s), where the parameters may include destination instructions for one or more of the job(s). If delegation module 128 receives a job and destination instructions indicating that the job is to be performed via lower-power compute unit 120, delegation module 128 may determine that the job is associated with the first class of jobs. Similarly, if delegation module 128 receives a job and destination instructions indicating that the job is to be performed via higher-power compute unit 110, delegation module 128 may determine that the job is associated with the second class of jobs. Further, if delegation module 128 receives a job and destination instructions indicating that the job is to be performed via companion compute unit 160, delegation module 128 may determine that the job is associated with the third class of jobs.

Delegation module 128 may determine a class for the job based on a service repository accessible to lower-power compute unit 120. The service repository may indicate a set of services, a location of each service, and/or a set of jobs associated with each service. For example, delegation module 128 may receive a job for performing a web request. The service repository may indicate that web requests are associated with a web request service of service module 166 at companion compute unit 160. Therefore, delegation module 128 may determine that the job is associated with the third class of jobs based on the service repository.

The service repository may additionally indicate service conditions associated with each service. For instance, the service repository may indicate that a message service of service module 166 is to receive jobs for transmitting a message via Short Message Service (SMS) only if computing device 100 is wirelessly connected to companion device 150. The service repository may indicate that, if computing device 100 is not wirelessly connected to companion device 150, a message service of service module 116 is to receive jobs for transmitting a message via SMS. In this example, if computing device 100 is wirelessly connected to companion device 150, delegation module 128 may determine that a job for transmitting a message via SMS is associated with the third class of jobs. If computing device 100 is not wirelessly connected to companion device 150, delegation module 128 may determine that the job is associated with the second class of jobs.

The service conditions may be based on, for example, available compute units, hardware topology, battery level, utilization level, instruction set capability, and/or thermal status of a component of computing device 100 or companion device 150. For instance, the service repository may indicate that a location service of service module 116 is to receive jobs for determining a location of computing device 100 only if a battery of computing device 100 is above a threshold. The service repository may indicate that, if the battery is not above the threshold, a location service of service module 126 is to receive jobs for determining a location of computing device 100. In this example, if the battery of computing device 100 is above the threshold, delegation module 128 may determine that a job for determining a location of computing device 100 is associated with the second class of jobs. If the battery level is not above the threshold, delegation module 128 may determine that the job is associated with the first class of jobs.

After determining a class associated with a job, delegation module 128 may delegate the job to a compute unit based on the class. To delegate the job, delegation module 128 may invoke a service of the compute unit via a function call, such as an API function call. Other techniques for delegating the job may implement Remote Procedure Call (RPC), a message queue, a publish/subscribe system, socket communication (e.g., Transmission Control Protocol (TCP) and/or User Datagram Protocol (UDP)), task scheduling via shared storage, event-driven execution, and distributed scheduling.

In response to determining that the job is associated with the first class of jobs, lower-power compute unit 120 may perform the job, e.g., via a wireless network connection of computing device 100. For example, after determining that a job is associated with the first class of jobs, delegation module 128 may delegate the job to lower-power compute unit 120. After receiving the delegated job, lower-power compute unit 120 may perform the job via a service of service module 126. Lower-power compute unit 120 may then indicate a result of the job to delegation module 128 or some other component of computing device 100 or companion device 150.

In response to determining that the job is associated with the second class of jobs, higher-power compute unit 110 may perform the job e.g., via a wireless network connection of computing device 100. For example, after determining that a job is associated with the second class of jobs, delegation module 128 may delegate the job to higher-power compute unit 110. After receiving the delegated job, higher-power compute unit 110 may perform the job via a service of service module 116. Higher-power compute unit 110 may then indicate a result of the job to delegation module 128 or some other component of computing device 100 or companion device 150.

In response to determining that the job is associated with the third class of jobs, lower-power compute unit 120 may transmit the job to companion device 150 and receive, from companion device 150, a result based on performing the job. For example, after determining that a job is associated with the third class of jobs, delegation module 128 may delegate the job to companion compute unit 160. After receiving the delegated job, companion compute unit 160 may perform the job via a service of service module 166. Companion compute unit 160 may then indicate a result of the job to delegation module 128 or some other component of computing device 100 or companion device 150.

The techniques described herein for delegating work facilitate intuitive software development and deployment. For example, delegation module 128 may act as an intermediary between a software developer and various components of computing device 100 and companion device 150. Instead of issuing multiple function calls to various components to perform work, a developer can instead issue one function call to delegation module 128, thus simplifying the development process. Additionally, various aspects of the present disclosure enable software to be cross-compatible with various hardware topologies despite hardware differences. For instance, delegation module 128 may account for the hardware capabilities of computing device 100 and delegate work accordingly. Therefore, a single version of software may operate on different hardware architectures without needing to account for hardware capabilities when utilizing device services.

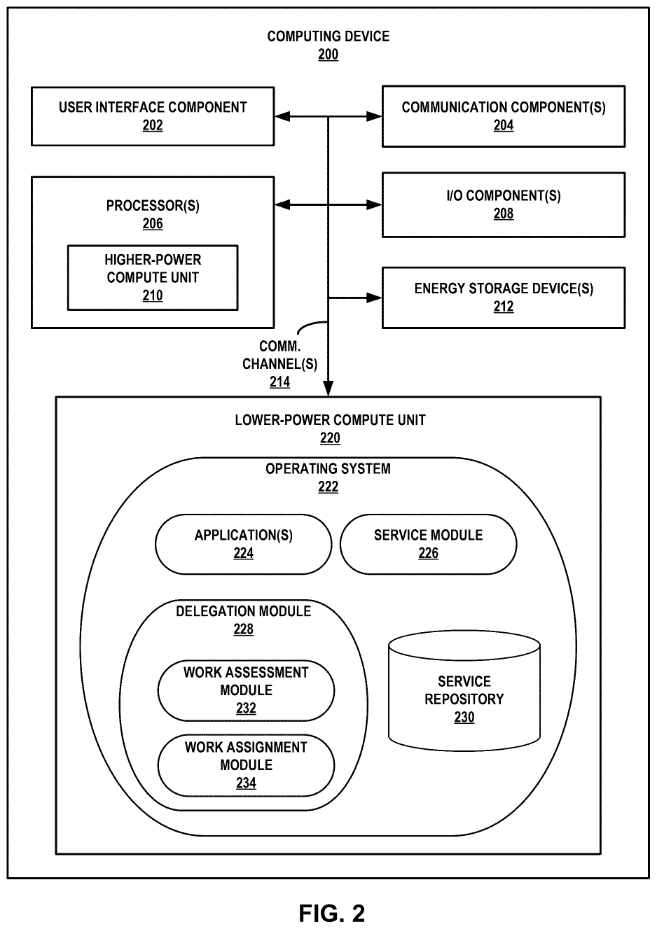

FIG. 2 is a conceptual diagram illustrating another example computing system for delegating work, in accordance with one or more techniques of this disclosure. In the example of FIG. 2, computing device 200 may be an individual mobile or non-mobile computing device. Examples of computing device 200 include a mobile phone, a tablet computer, a laptop computer, a desktop computer, a server, a mainframe, a set-top box, a television, a wearable device (e.g., a computerized watch, computerized eyewear, computerized headphones, computerized gloves, computerized ring, etc.), a home automation device or system (e.g., an intelligent thermostat or home assistant device), a gaming system, a media player, an e-book reader, a mobile television platform, an augmented reality device, a virtual reality device, a mixed reality device, an automobile navigation or infotainment system, or any other type of mobile, non-mobile, wearable device, and non-wearable device configured to delegate work in accordance with techniques of this disclosure. Computing device 200 may implement various compute resources, such as processors, memory, data storage, data buses, input/output controllers, network interfaces, accelerators (e.g., graphics accelerators), and power management units.

Computing device 200 includes UIC 202. UIC 202 may function as an input and/or output device for computing device 200 and may be implemented using various technologies. For instance, UIC 202 may function as an input device using presence-sensitive input screens, microphone technologies, infrared sensor technologies, or other input device technology for use in receiving user input. UIC 202 may function as an output device configured to present output to a user using any one or more display devices, speaker technologies, haptic feedback technologies, or other output device technology for use in outputting information to a user.

One or more communication components 204 of computing device 200 may communicate with external devices via one or more wired and/or wireless networks by transmitting and/or receiving network signals on the one or more networks. Examples of communication components 204 include a network interface card (e.g., an Ethernet card), an optical transceiver, a radio frequency transceiver, a GPS receiver, or any other type of device that can send and/or receive information. Other examples of communication components 204 may include short wave radios, cellular data radios, wireless network radios, as well as USB controllers. Communication components 204 may send and receive information from communication components of a companion device (e.g., companion device 150).

One or more processors 206 may implement functionality and/or execute instructions within computing device 200. Processors 206 may implement computational components such as arithmetic logic units, control units, registers, pipelines, execution cores, caches (e.g., L1, L2, and L3), and branch predictors. Processors 206 may operate based on a fetch-decode-execute cycle, where processors 206 retrieve instructions from memory, decode the instructions into operations, and execute the instructions via various functional units. Further, processors 206 may implement instruction sets that define software and hardware communication at a binary level. Each processor of processors 206 may include multiple cores and may support multiple threads, and may perform techniques such as parallel processing, graphics rendering, and multimedia processing. Examples of processors 206 include CPUs, GPUs, APs, DSPs, NPUs, ISPs, accelerated processing units (APUs), field-programmable gate arrays (FPGAs), tensor processing units (TPUs), and microcontrollers.

Processors 206 include higher-power compute unit 210. Higher-power compute unit 210 may be a primary processor and/or computing system configured to perform resource-intensive tasks via a general-purpose instruction set. For instance, higher-power compute unit 210 may be an AP, CPU, GPU, or any combination thereof. Higher-power compute unit 210 may include multiple cores and may support multiple threads, and may perform techniques such as parallel processing, graphics rendering, and multimedia processing.

In some implementations, higher-power compute unit 210 may include compute resources such as memory, data storage, and a multimedia encoder/decoder. For instance, higher-power compute unit 210 may be an SOC including an AP, memory, and a memory encoder. Further, higher-power compute unit 210 may utilize compute resources of computing device 200. For example, higher-power compute unit 210 may implement memory and data storage of computing device 200 to perform operations. Higher-power compute unit 210 may offer platform-level or system-level services, such as location services, sensor services, network services, power management services, and file system services.

One or more input/output (I/O) components 208 may receive input and provide output for computing device 200. I/O components 208 may provide output by, for example, making information perceivable to an external component or user. I/O components 208 may convert data produced by computing device 200 into a user-understandable or machine-interpretable format, such as a visual, audio, or physical format. Examples of output components of I/O components 208 include display devices (e.g., monitors and projectors), audio output devices (e.g., speakers and headphones), haptic output devices, printers, actuators, network interfaces, and storage devices. I/O components 208 may also provide input for computing device 200 by, for example, converting external signals into machine-readable formats. Examples of input components of I/O components 208 include user input devices (e.g., keyboards, mice, presence-sensitive screens, and game controllers), audio input devices (e.g., microphones), image input devices (e.g., cameras and scanners), thermometers, accelerometers, motion detectors, biometric devices, network interfaces, and storage devices.

Computing device 200 further includes one or more energy storage devices 212. Energy storage devices 212 may accumulate, store, and/or release energy for use by computing device 200. Energy storage devices 212 may be characterized by parameters such as energy density, efficiency, charge rate, and discharge rate. Further, energy storage devices 212 may include batteries, fuel cells, capacitors, and/or any other device configured to store energy.

Communication channels 214 may interconnect each of UIC 202, communication components 204, processors 206, I/O components 208, energy storage devices 212, and lower-power compute unit 220 for inter-component communications (physically, communicatively, and/or operatively). In some examples, communication channels 214 may include a system bus, a network connection, an inter-process communication data structure, or any other method for communicating data.

Computing device 200 also includes lower-power compute unit 220. Lower-power compute unit 220 may be a specialized processor and/or computing system configured to perform tasks that are less resource-intensive than those performed by higher-power compute unit 210. For instance, lower-power compute unit 220 may be a MCU, sensor hub, DSP, NPU, ISP, or any combination thereof. Additionally, or alternatively, lower-power compute unit 220 may be a subset of a primary processor of processors 206. For instance, lower-power compute unit 220 may be an always-on core of a multi-core processor. Lower-power compute unit 220 may support a specialized instruction set and may perform techniques such as image processing, lightweight control logic, and background processing.

Lower-power compute unit 220 may be less computationally capable than higher-power compute unit 210. For example, lower-power compute unit 220 may have a lower clock speed, a decreased core count, reduced instruction set capabilities, a smaller cache size, and/or less memory bandwidth. However, lower-power compute unit 220 generally consumes less power than higher-power compute unit 210. For instance, higher-power compute unit 210 consumes more power to complete a task than lower-power compute unit 220 consumes for the same task. To conserve power, computing device 200 may perform operations via lower-power compute unit 220 while higher-power compute unit 210 remains in a sleep state or idle state. Higher-power compute unit 210 may wake to perform tasks according to a schedule or in response receiving an unscheduled wake event.

In some implementations, lower-power compute unit 220 may include compute resources such as memory, data storage, and input/output structures. For instance, lower-power compute unit 220 unit may be an SOC including a microcontroller and memory. In some implementations, lower-power compute unit 220 may be included in an SOC, the SOC also including higher-power compute unit 210 and/or other components of computing device 200. Further, lower-power compute unit 220 may utilize compute resources of computing device 200. For example, lower-power compute unit 220 may implement memory and data storage of computing device 200 to perform operations. Lower-power compute unit 220 may offer platform-level or system-level services, such as location services, sensor services, network services, power management services, and file system services.

Lower-power compute unit 220 executes OS 222, OS 222 including applications 224, service module 226, delegation module 228, and service repository 230. OS 222, applications 224, and delegation module 228 may perform operations described herein using software, hardware, firmware, or a mixture of hardware, software, and firmware residing in and/or executing at computing device 200 or lower-power compute unit 220. In some implementations, lower-power compute unit 220 may execute OS 222 and applications 224 as virtual machines executing on underlying hardware, as one or more services of an operating system or computing platform, and/or as one or more executable programs at an application layer of lower-power compute unit 220.

OS 222 manages hardware resources and provides a platform for software execution at lower-power compute unit 220. OS 222 may perform scheduling algorithms (e.g., round-robin and multilevel queues), allocate memory via virtual memory management and paging mechanisms, and facilitate IPC via message queues, pipes, and shared memory. OS 222 may implement preemptive multitasking, real-time scheduling for deterministic latency, and dynamic power management to improve performance and power consumption of lower-power compute unit 220.

Applications 224 may be first-party, second-party, or third-party applications of OS 222. Applications 224 may extend software functionality of lower-power compute unit 220, where applications 224 may execute within an execution environment presented by OS 222. Applications 224 may, as a few examples, provide gaming services (e.g., video games), email services, web browsing services, texting and/or chat services, web conferencing services, video conferencing services, music services (including streaming music services), video services (including video streaming services), navigation services, weather services, word processing services, spreadsheet services, slide and/or presentation services, assistant services, text entry services, network access services, or any other application service. Some applications of applications 224 may also be applications of higher-power compute unit 210. For instance, a location tracking application may operate on both lower-power compute unit 220 and higher-power compute unit 210.

Service module 226 may perform jobs via services offered by applications 224, OS 222, or lower-power compute unit 220. Service module 226 may receive a job from a component of computing device 200, such as lower-power compute unit 220 or delegation module 228, and may transmit results to a component based on performing the service. For example, service module 226 may receive a job for determining a location of computing device 200. Service module 226 may implement a position system component of computing device 200 to determine the location and may then transmit the location to a component of computing device 200.

Delegation module 228 may delegate jobs to various components of computing device 200 and/or a companion device (e.g., companion device 150). For instance, delegation module 228 may receive a job from a component of computing device 200. Responsive to receiving the job, delegation module 228 may classify the job to determine a destination for the job. Delegation module 228 may then transmit all or part of the job to the destination. For instance, delegation module 228 may transmit all or part of the job to higher-power compute unit 210. Additionally, or alternatively, delegation module 228 may transmit all or part of the job to companion device 150 via communication components 204.

Delegation module 228 includes work assessment module 232 and work assignment module 234. Work assessment module 232 may assess a job to determine if the job is associated with a first class, a second class, or a third class. First-class jobs may be associated with lower-power compute unit 220, second-class jobs may be associated with higher-power compute unit 210, and third-class jobs may be associated with a companion compute unit (e.g., companion compute unit 160). Work assessment module 232 may implement one or more techniques to determine an associated class for the job.

In some implementations, the job is received alongside additional parameters. For example, lower-power compute unit 220 may receive the job via an API function call, the function call including destination instructions (e.g., instructions that the job be performed by lower-power compute unit 220, higher-power compute unit 210, or companion compute unit 160). Work assessment module 232 may determine if the job is associated with the first class of jobs, the second class of jobs, or the third class of jobs based on the destination instructions. For instance, work assessment module 232 may determine that, for a job associated with destination instructions indicating that the job is to be performed by lower-power compute unit 220, the job is associated with the first class of jobs.

Delegation module 228 may receive a job and associated input for the job. For example, delegation module 228 may receive a job for checking if a firmware update is available for computing device 200. The job may be received along with a current firmware version of computing device 200. After determining an associated class for the job, delegation module 228 may transmit the job to a separate compute unit (e.g., higher-power compute unit 210 or companion compute unit 160) along with the input.

As discussed, work assessment module 232 may determine if the job is associated with the first class of jobs, the second class of jobs, or the third class of jobs based on one or more classification factors associated with the job, the classification factors including time complexity, space complexity, input size, power consumption, and specialized operation specification. For example, jobs associated with larger time complexity, space complexity, input size, or power consumption may be better suited for more powerful compute units, such as higher-power compute unit 210 or companion compute unit 160. Therefore, work assessment module 232 may be more likely to determine that the job is associated with the second class or third class of jobs.

In one example, a job for checking and applying system updates is received at delegation module 228. The job has an input size of 32 kilobytes (KBs). Work assessment module 232 may be configured to classify jobs having an input size below 16 KBs as being associated with the first class of jobs, jobs having an input size below 64 KBs as being associated with the second class of jobs, and other jobs as being associated with the third class of jobs. Therefore, work assessment module 232 may determine that the job for checking and applying system updates is associated with the second class of jobs.

After work assessment module 232 determines a class for a job, work assignment module 234 may transfer the job and relevant data to a destination based on the class. Additionally, or alternatively, work assignment module 234 initiates execution of the job. In some implementations, first-class jobs are associated with lower-power compute unit 220. Work assignment module 234 may initiate services of service module 226 to execute first-class jobs. For example, work assessment module 232 may associate a job for collecting sensor data with the first class of jobs. Based on the first-class association, work assignment module 234 may delegate the job to lower-power compute unit 220 (e.g., an MCU). Specifically, work assignment module 234 may initiate an API call to an accelerometer service of service module 226. Other techniques work assignment module 234 may implement to transfer and/or initiate jobs to lower-power compute unit 220, higher-power compute unit 210, and/or companion compute unit 160 include message passing via asynchronous message queues, event-driven callbacks, IPC, RPC, shared memory access, and task scheduling via a centralized job queue manager.

Service repository 230 may store information and instructions for delegating jobs. For instance, determining if a job is associated with the first class of jobs, the second class of jobs, or the third class of jobs may be based on service repository 230, service repository 230 including a set of services, a location of each service of the set of services, and transmission instructions for jobs associated with the first class of jobs, the second class of jobs, or the third class of jobs. The set of services may include services of service module 116, service module 226, and/or service module 166. For example, service repository 230 may store information for a location tracking service of service module 116, a location tracking service of service module 226, an audio output service of service module 116, and a web request service of service module 226.

The location of each service of the set of services may refer to a computing device configured to perform the service, or a component of the computing device that is configured to perform the service. For instance, the location of a heart rate tracking service may be computing device 200, or a component of computing device 200, such as a sensor hub. Additionally, or alternatively, the location of each service may be a destination for use by work assignment module 234 when transmitting and/or initiating the service. For example, the location may refer to a shared memory access point or a centralized job queue manager.

Work assignment module 234 may transfer and/or initiate jobs based on transmission instructions stored at service repository 230. For example, lower-power compute unit 220 may transmit jobs based on the transmission instructions associated with a service or job stored at service repository 230. The transmission instructions may include information for initiating a service to complete a job. In some implementations, the transmission instructions include syntax for API calls to a service, pointers to pertinent memory regions, references to data buffers, input parameters of the service, authentication tokens, data serialization formatting information, and/or callback references.

Work assessment module 232 may determine a plurality of base jobs by comparing a job to a set of documented jobs stored at service repository 230, each documented job associated with one or more respective base jobs. In some examples, service repository 230 may store a set of documented jobs that may each be broken down to a set of base jobs associated with the respective documented job at service repository 230. For instance, service repository 230 may include a documented job for updating weather data at UIC 202. Service repository 230 may associate the documented job for retrieving weather data with a base job for issuing a web request to fetch weather data via I/O components 208 and a base job for updating a weather UI element via higher-power compute unit 210. Service repository 230 may store a set of services associated with each base job, a location of each service of the set of services, and transmission instructions associated with each base job.

Work assessment module 232 may determine, for each base job of the plurality of base jobs, if the respective base job is associated with the first class of jobs, the second class of jobs, or the third class of jobs. In some implementations, work assessment module 232 may use the same techniques it uses to determine if a job is associated with the first class of jobs, the second class of jobs, or the third class of jobs. For instance, service repository 230 may store instructions indicating that a first base job is associated with a component of lower-power compute unit 220 and a second base job is associated with higher-power compute unit 210. Work assessment module 232 may therefore determine that the first base job is associated with the first class of jobs and the second base job is associated with the second class of jobs.

Responsive to determining that one or more base jobs of the plurality of base jobs are associated with the first class of jobs, work assignment module 234 may initiate services at service module 226 to have lower-power compute unit 220 perform the one or more base jobs associated with the first class of jobs. Responsive to determining that one or more base jobs of the plurality of base jobs are associated with the second class of jobs, work assignment module 234 may initiate services at higher-power compute unit 210 to have higher-power compute unit 210 perform the one or more base jobs associated with the second class of jobs. Responsive to determining that one or more base jobs of the plurality of base jobs are associated with the third class of jobs, work assignment module 234 may transmit the one or more base jobs associated with the third class of jobs to companion device 150. Computing device 200 may the receive, from companion device 150, one or more results based on performing the base jobs associated with the third class of jobs.

In some implementations, work assignment module 234 may create a queue to handle one or more related jobs (e.g., a base job that depends on the results of another base job). For example, service repository 230 may associate a documented job for retrieving weather data with a base job for issuing a web request to fetch weather data via I/O components 208 and a base job for updating a weather UI element via higher-power compute unit 210. Work assignment module 234 may initiate the base job for issuing the web request, and in response to receiving a result of the web request, initiate the base job for updating the weather UI element based on the received result. Additionally, or alternatively, work assignment module 234 may initiate a first job along with instructions to complete a second job based on the results of the first job. For example, work assignment module 234 may transmit a first job for collecting sensor data to higher-power compute unit 210 with instructions that higher-power compute unit 210 transmit the results and a second job for uploading the results to a remote server to companion compute unit 160.

As discussed, higher-power compute unit 210 may be an AP and lower-power compute unit 220 may be an MCU, the AP using a different OS than the MCU. For example, the AP may use a Rust-based OS while the MCU uses an OS such as FreeRTOS. Delegation module 228 may interact with the AP via a dedicated delegation API.

In some implementations, work assessment module 232 may determine if a job is associated with the first class of jobs, the second class of jobs, or the third class of jobs based on one or more of a battery state, thermal state, utilization state, or hardware topology of the computing device 200 and/or companion device 150. For example, if the battery state of energy storage devices 212 is below a threshold, work assessment module 232 may be configured to designate jobs as being associated with the third class of jobs. Similarly, if the thermal state and/or utilization state of computing device 200 is above a threshold, work assessment module 232 may be configured to designate jobs as being associated with the first or second class of jobs.

Work assessment module 232 may implement classification factors, a battery state, a thermal state, a utilization state, and hardware topology to determine a class associated with a job based on instructions stored at service repository 230 for each documented job. For example, service repository 230 may store instructions that a job for issuing a web request is to be performed by higher-power compute unit 210 if higher-power compute unit 210 is in a wake state. Otherwise, the job is to be performed by lower-power compute unit 220. If delegation module 228 receives a job for issuing a web request, work assessment module 232 may determine that the job is associated with the second class of jobs based on the instructions, if higher-power compute unit 210 is in a wake state. If higher-power compute unit 210 is in a sleep state, work assessment module 232 may determine that the job is associated with the first class of jobs, based on the instructions.

As discussed, work assessment module 232 may determine if a job is associated with the first class of jobs, the second class of jobs, or the third class of jobs based on hardware topology of computing device 200 and/or companion device 150. For example, service repository 230 may store instructions that computing device 200 (e.g., lower-power compute unit 220 or higher-power compute unit 210) is to perform jobs for transmitting a Short Message Service (SMS) message if communication components 204 include Long Term Evolution (LTE) functionality. Otherwise, companion device 150 is to perform jobs for transmitting SMS messages. Work assessment module 232 may therefore determine a class for an SMS transmission job based on the hardware topology of computing device 200. Delegation module 228 may poll other components of computing device 200 and/or companion device 150 to assess classification factors, battery state, thermal state, utilization state, and hardware topology prior to determining a class for a job.

In some implementations, lower-power compute unit 220 and/or companion compute unit 160 may perform jobs while higher-power compute unit 210 remains in a sleep state. For example, determining a class associated with a job, performing the job by lower-power compute unit 220, transmitting a job to companion device 150, and receiving the result may occur while higher-power compute unit 210 is in a sleep state.

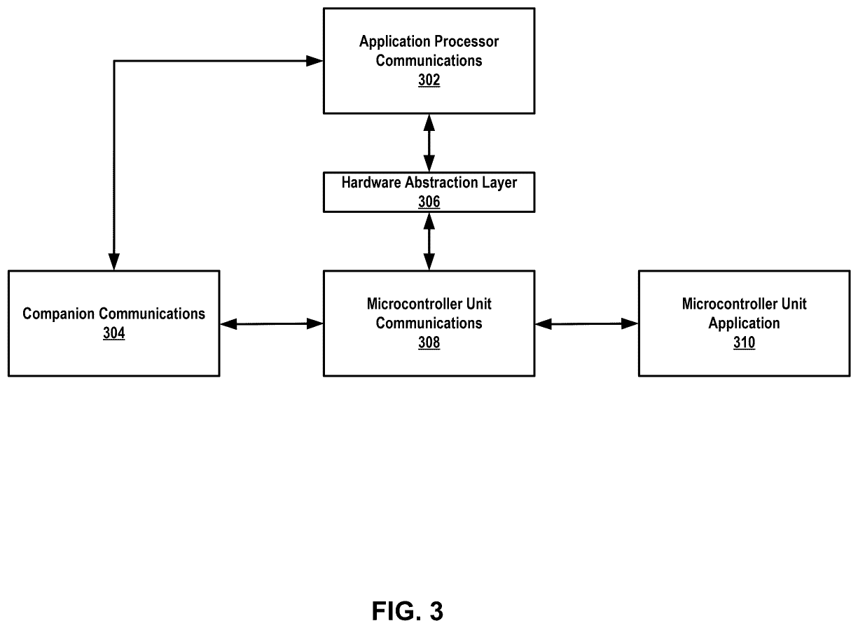

FIG. 3 is a conceptual diagram illustrating example communication techniques via various APIs, in accordance with one or more techniques of this disclosure. As shown in FIG. 3, AP communications 302 is in communication with companion communications 304. AP communications 302 may be a software component (e.g., an API) of higher-power compute unit 110 for communicating with other components of computing device 100 and/or companion device 150. For example, AP communications 302 may be in communication with companion communications 304 via a wireless communication channel, such as a BLUETOOTH channel. AP communications 302 may also be in communication with MCU communications 308 via hardware abstraction layer 306.

Companion communications 304 may be a software component (e.g., an API) of companion compute unit 160 for communicating with components of computing device 100, such as higher-power compute unit 110 and lower-power compute unit 120. For example, companion communications 304 may be in communication with higher-power compute unit 110 via AP communications 302 and in communication with lower-power compute unit 120 via MCU communications 308.

MCU communications 308 may be a software component (e.g., an API) of lower-power compute unit 120 for communicating with components of computing device 100 and/or companion device 150, such as higher-power compute unit 110 and companion compute unit 160. For example, MCU communications 308 may be in communication with higher-power compute unit 110 via AP communications 302 and in communication companion compute unit 160 via companion communications 304. MCU communications 308 may send and receive information to AP communications 302 via hardware abstraction layer 306. Further, MCU communications 308 may send and receive information from companion communications 304 via a wireless communication channel, such as an offloaded BLUETOOTH channel.

Hardware abstraction layer 306 may be a software layer that provides an interface between AP communications 302 and MCU communications 308. Further, hardware abstraction layer 306 may abstract hardware-specific details to make communication between AP communications 302 and MCU communications 308 more intuitive for developers. As discussed, higher-power compute unit 110 and lower-power compute unit 120 may use different operating systems. Therefore, hardware abstraction layer 306 may offer a standardized API to enable communication across the different operating systems.

MCU application 310 may be an application of lower-power compute unit 120 (e.g., an application of applications 124). MCU application 310 may perform tasks by leveraging resources of lower-power compute unit 120. For example, MCU application 310 may be an application for monitoring a user's vital signs and updating a GUI in response to data generated based on the vital signs. MCU application 310 may communication with AP communications 302 and companion communications 304 via MCU communications 308.

According to various aspects of the present disclosure, MCU communications 308 may include a job-delegation service configured to receive jobs. For example, the job-delegation service of MCU communications 308 may receive a job for getting weather data via a web request. The job-delegation service may invoke a service of higher-power compute unit 110 or companion compute unit 160 to perform the web request. For example, the job-delegation service may request, via companion communications 304, that companion compute unit 160 perform the web request and transmit a result back to MCU communications 308 or AP communications 302.

MCU communications 308 may also be configured to provide a set of available services registered by the job-delegation service. For example, MCU communications 308 may provide a description of services that the job-delegation service is configured to delegate jobs to. The job-delegation service may be, for example, a component of delegation module 128. Furthermore, AP communications 302 and companion communications 304 may be configured to register available services at MCU communications 308 by, e.g., issuing a function call to register the service.

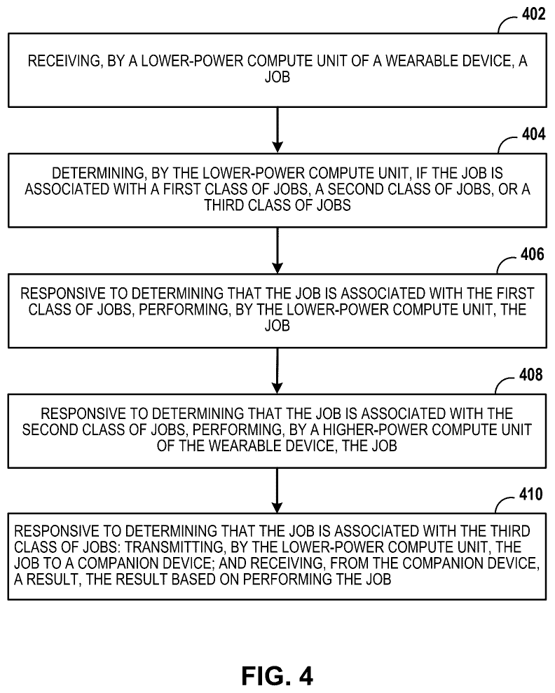

FIG. 4 is a flowchart illustrating an example operation for delegating work among compute units, in accordance with one or more techniques of this disclosure. FIG. 4 may be discussed with respect to FIG. 1 for example purposes only.

A technique for delegating work may include receiving, by a lower-power compute unit of a wearable device, a job (402). For example, an application of computing device 100 may initiate an API function call to delegation module 128 of lower-power compute unit 120, where the API function call includes a job and parameters such as destination instructions. As discussed, lower-power compute unit 120 may be an MCU while higher-power compute unit 110 may be an AP. In some examples, applications 114 of higher-power compute unit 110 (e.g., the AP), may initiate the function call.

The technique may further include determining, by the lower-power compute unit, if the job is associated with a first class of jobs, a second class of jobs, or a third class of jobs (404). Lower-power compute unit 120 may determine if the job is associated with the first class of jobs, the second class of jobs, or the third class of jobs based on one or more classification factors associated with the job, including time complexity, space complexity, input size, power consumption, and specialized operation specification. In some implementations, lower-power compute unit 120 may also make the determination based on a battery state, a thermal state, a utilization state, and/or a hardware topology of computing device 100 and/or companion device 150.

In some examples, computing device 100 may implement a service repository (e.g., service repository 230) to determine an associated class for a job based on classification factors and/or other factors. Service repository 230 may store transmission instructions directing delegation module 128 to determine an associated class based on classification factors and/or other factors. For instance, service repository 230 may store transmission instructions directing delegation module 128 to associate jobs having a first specialized operation specification with the first class of jobs, to associate jobs having a second specialized operation specification with the second class of jobs, and to associate jobs having a third specialized operation specification with the third class of jobs. The specialized operation specification may provide execution criteria defining how a specific task or operation should be performed.

The technique may also include, responsive to determining that the job is associated with the first class of jobs, performing, by the lower-power compute unit, the job (406). For example, delegation module 128 may receive a job for transmitting health statistics to companion device 150. If delegation module 128 determines that the job is associated with the first class of jobs, then service module 126 may perform the job via communication components 104. After transmitting the health statistics, service module 126 may provide an indication that the job is complete to a destination indicated by parameters received along with the job.

The technique may additionally include, responsive to determining that the job is associated with the second class of jobs, performing, by a higher-power compute unit of the wearable device, the job (408). For example, delegation module 128 may receive a job for updating a UI component. If delegation module 128 determines that the job is associated with the second class of jobs, then delegation module 128 may initiate service module 116 so that service module 116 may perform the job via UIC 102.

The technique may further include, responsive to determining that the job is associated with the third class of jobs: transmitting, by the lower-power compute unit, the job to a companion device; and receiving, from the companion device, a result, the result based on performing the job (410). For instance, delegation module 128 may receive a job for rendering a graphic. If delegation module 128 determines that the job is associated with the third class of jobs, then delegation module 128 may initiate service module 166 so that service module 166 may perform the job via companion compute unit 160. Companion device 150 may then return a rendered graphic to a component of computing device 100 based on instructions received from delegation module 128.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, various units may be combined in a hardware unit or provided by a collection of intraoperative hardware units, including one or more processors, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Example 1: A method includes receiving, by a lower-power compute unit of a wearable device, a job; determining, by the lower-power compute unit, if the job is associated with a first class of jobs, a second class of jobs, or a third class of jobs; responsive to determining that the job is associated with the first class of jobs, performing, by the lower-power compute unit, the job; responsive to determining that the job is associated with the second class of jobs, performing, by a higher-power compute unit of the wearable device, the job; and responsive to determining that the job is associated with the third class of jobs: transmitting, by the lower-power compute unit, the job to a companion device; and receiving, from the companion device, a result, the result based on performing the job.

Example 2: The method of example 1, wherein performing the job by the lower-power compute unit, transmitting the job to the companion device, and receiving the result occur while the higher-power compute unit is in a sleep state.

Example 3: The method of any of examples 1 and 2, wherein determining if the job is associated with the first class of jobs, the second class of jobs, or the third class of jobs is based on one or more classification factors associated with the job, the classification factors including time complexity, space complexity, input size, power consumption, and specialized operation specification.

Example 4: The method of any of examples 1 through 3, wherein determining if the job is associated with the first class of jobs, the second class of jobs, or the third class of jobs is based on one or more of a battery state, thermal state, utilization state, or hardware topology of the wearable device.

Example 5: The method of any of examples 1 through 4, wherein the higher-power compute unit is an application processor and the lower-power compute unit is a microcontroller unit, the application processor using a different operating system than the microcontroller unit.

Example 6: The method of any of examples 1 through 5, wherein: determining if the job is associated with the first class of jobs, the second class of jobs, or the third class of jobs is based on a service repository accessible to the lower-power compute unit, the service repository including a set of services, a location of each service of the set of services, and transmission instructions for jobs associated with the first class of jobs, the second class of jobs, or the third class of jobs; and the lower-power compute unit transmits jobs based on the transmission instructions.

Example 7: The method of any of examples 1 through 6, further including: determining, by the lower-power compute unit, a plurality of base jobs by comparing the job to a set of documented jobs stored at the service repository, each documented job associated with one or more respective base jobs; determining, by the lower-power compute unit, for each base job of the plurality of base jobs, if the respective base job is associated with the first class of jobs, the second class of jobs, or the third class of jobs; responsive to determining that one or more base jobs of the plurality of base jobs are associated with the first class of jobs, performing, by the lower-power compute unit, one or more base jobs associated with the first class of jobs; responsive to determining that one or more base jobs of the plurality of base jobs are associated with the second class of jobs, performing, by the higher-power compute unit, one or more base jobs associated with the second class of jobs; and responsive to determining that one or more base jobs of the plurality of base jobs are associated with the third class of jobs: transmitting, by the lower-power compute unit, one or more base jobs associated with the third class of jobs to the companion device; and receiving, from the companion device, one or more results, the one or more results based on performing the one or more base jobs associated with the third class of jobs.

Example 8: The method of any of examples 1 through 7, wherein: the job is received via an application programming interface function call, the application programming interface function call including destination instructions; and determining if the job is associated with the first class of jobs, the second class of jobs, or the third class of jobs is based on the destination instructions.

Example 9: A computing system includes one or more processors; and one or more storage devices storing instructions that, when executed by the one or more processors, cause the one or more processors to: receive a job; determine if the job is associated with a first class of jobs, a second class of jobs, or a third class of jobs; responsive to determining that the job is associated with the first class of jobs, perform, by a lower-power compute unit of the one or more processors, the job; responsive to determining that the job is associated with the second class of jobs, perform, by a higher-power compute unit of the one or more processors, the job; and responsive to determining that the job is associated with the third class of jobs: transmit the job to a companion device; and receive a result, the result based on performing the job.

Example 10: The computing system of example 9, wherein performing the job by the lower-power compute unit, transmitting the job to the companion device, and receiving the result occur while the higher-power compute unit is in a sleep state.

Example 11: The computing system of any of examples 9 and 10, wherein determining if the job is associated with the first class of jobs, the second class of jobs, or the third class of jobs is based on one or more classification factors associated with the job, the classification factors including time complexity, space complexity, input size, power consumption, and specialized operation specification.

Example 12: The computing system of any of examples 9 through 11, wherein determining if the job is associated with the first class of jobs, the second class of jobs, or the third class of jobs is based on one or more of a battery state, thermal state, utilization state, or hardware topology of the wearable device.

Example 13: The computing system of any of examples 9 through 12, wherein the higher-power compute unit is an application processor and the lower-power compute unit is a microcontroller unit, the application processor using a different operating system than the microcontroller unit.

Example 14: The computing system of any of examples 9 through 13, wherein: determining if the job is associated with the first class of jobs, the second class of jobs, or the third class of jobs is based on a service repository accessible to the lower-power compute unit, the service repository including a set of services, a location of each service of the set of services, and transmission instructions for jobs associated with the first class of jobs, the second class of jobs, or the third class of jobs; and the lower-power compute unit transmits jobs based on the transmission instructions.

Example 15: The computing system of any of examples 9 through 14, wherein the instructions further cause the one or more processors to: determine a plurality of base jobs by comparing the job to a set of documented jobs stored at the service repository, each documented job associated with one or more respective base jobs; determine, for each base job of the plurality of base jobs, if the respective base job is associated with the first class of jobs, the second class of jobs, or the third class of jobs; responsive to determining that one or more base jobs of the plurality of base jobs are associated with the first class of jobs, perform, by the lower-power compute unit, one or more base jobs associated with the first class of jobs; responsive to determining that one or more base jobs of the plurality of base jobs are associated with the second class of jobs, perform, by the higher-power compute unit, one or more base jobs associated with the second class of jobs; and responsive to determining that one or more base jobs of the plurality of base jobs are associated with the third class of jobs: transmit one or more base jobs associated with the third class of jobs to the companion device; and receive one or more results, the one or more results based on performing the one or more base jobs associated with the third class of jobs.

Example 16: The computing system of any of examples 9 through 15, wherein: the job is received via an application programming interface function call, the application programming interface function call including destination instructions; and determining if the job is associated with the first class of jobs, the second class of jobs, or the third class of jobs is based on the destination instructions.

Example 17: A non-transitory computer-readable storage medium comprising instructions, that when executed by one or more processors of a computing system, cause the one or more processors to: receive a job; determine if the job is associated with a first class of jobs, a second class of jobs, or a third class of jobs; responsive to determining that the job is associated with the first class of jobs, perform, by a lower-power compute unit of the one or more processors, the job; responsive to determining that the job is associated with the second class of jobs, perform, by a higher-power compute unit of the one or more processors, the job; and responsive to determining that the job is associated with the third class of jobs: transmit the job to a companion device; and transmit a result, the result based on performing the job.

Example 18: The non-transitory computer-readable storage medium of example 17, wherein performing the job by the lower-power compute unit, transmitting the job to the companion device, and receiving the result occur while the higher-power compute unit is in a sleep state.

Example 19: The non-transitory computer-readable storage medium of any of examples 17 and 18, wherein determining if the job is associated with the first class of jobs, the second class of jobs, or the third class of jobs is based on one or more classification factors associated with the job, the classification factors including time complexity, space complexity, input size, power consumption, and specialized operation specification.

Example 20: The non-transitory computer-readable storage medium of any of examples 17 through 19, wherein determining if the job is associated with the first class of jobs, the second class of jobs, or the third class of jobs is based on one or more of a battery state, thermal state, utilization state, or hardware topology of the wearable device.

Example 21: The non-transitory computer-readable storage medium of any of examples 17 through 20, wherein the higher-power compute unit is an application processor and the lower-power compute unit is a microcontroller unit, the application processor using a different operating system than the microcontroller unit.

Example 22: The non-transitory computer-readable storage medium of any of examples 17 through 21, wherein: determining if the job is associated with the first class of jobs, the second class of jobs, or the third class of jobs is based on a service repository accessible to the lower-power compute unit, the service repository including a set of services, a location of each service of the set of services, and transmission instructions for jobs associated with the first class of jobs, the second class of jobs, or the third class of jobs; and the lower-power compute unit transmits jobs based on the transmission instructions.

Example 23: The non-transitory computer-readable storage medium of any of examples 17 through 22, wherein the one or more processors further execute the instructions to: determine a plurality of base jobs by comparing the job to a set of documented jobs stored at the service repository, each documented job associated with one or more respective base jobs; determine, for each base job of the plurality of base jobs, if the respective base job is associated with the first class of jobs, the second class of jobs, or the third class of jobs; responsive to determining that one or more base jobs of the plurality of base jobs are associated with the first class of jobs, perform, by the lower-power compute unit, one or more base jobs associated with the first class of jobs; responsive to determining that one or more base jobs of the plurality of base jobs are associated with the second class of jobs, perform, by the higher-power compute unit, one or more base jobs associated with the second class of jobs; and responsive to determining that one or more base jobs of the plurality of base jobs are associated with the third class of jobs: transmit one or more base jobs associated with the third class of jobs to the companion device; and receive one or more results, the one or more results based on performing the one or more base jobs associated with the third class of jobs.

Example 24: The non-transitory computer-readable storage medium of any of examples 17 through 23, wherein: the job is received via an application programming interface function call, the application programming interface function call including destination instructions; and determining if the job is associated with the first class of jobs, the second class of jobs, or the third class of jobs is based on the destination instructions.

Example 25: A computing system comprising means for performing any combination of examples 1 through 8.

Example 26: A computer program product comprising one or more instructions that, when executed by a computing device, cause the computing device to perform any combination of examples 1 through 8.

What is claimed is:

1. A method comprising:
receiving, by a lower-power compute unit of a wearable device, a job;
determining, by the lower-power compute unit, if the job is associated with a first class of jobs, a second class of jobs, or a third class of jobs;
responsive to determining that the job is associated with the first class of jobs, performing, by the lower-power compute unit, the job;
responsive to determining that the job is associated with the second class of jobs, performing, by a higher-power compute unit of the wearable device, the job; and
responsive to determining that the job is associated with the third class of jobs:
transmitting, by the lower-power compute unit, the job to a companion device; and
receiving, from the companion device, a result, the result based on performing the job.

2. The method of claim 1, wherein performing the job by the lower-power compute unit, transmitting the job to the companion device, and receiving the result occur while the higher-power compute unit is in a sleep state.

3. The method of claim 1, wherein determining if the job is associated with the first class of jobs, the second class of jobs, or the third class of jobs is based on one or more classification factors associated with the job, the classification factors including time complexity, space complexity, input size, power consumption, and specialized operation specification.

4. The method of claim 1, wherein determining if the job is associated with the first class of jobs, the second class of jobs, or the third class of jobs is based on one or more of a battery state, thermal state, utilization state, or hardware topology of the wearable device.

5. The method of claim 1, wherein the higher-power compute unit is an application processor and the lower-power compute unit is a microcontroller unit, the application processor using a different operating system than the microcontroller unit.

6. The method of claim 1, wherein:
determining if the job is associated with the first class of jobs, the second class of jobs, or the third class of jobs is based on a service repository accessible to the lower-power compute unit, the service repository including a set of services, a location of each service of the set of services, and transmission instructions for jobs associated with the first class of jobs, the second class of jobs, or the third class of jobs; and
the lower-power compute unit transmits jobs based on the transmission instructions.

7. The method of claim 6, further comprising:
determining, by the lower-power compute unit, a plurality of base jobs by comparing the job to a set of documented jobs stored at the service repository, each documented job associated with one or more respective base jobs;
determining, by the lower-power compute unit, for each base job of the plurality of base jobs, if the respective base job is associated with the first class of jobs, the second class of jobs, or the third class of jobs;
responsive to determining that one or more base jobs of the plurality of base jobs are associated with the first class of jobs, performing, by the lower-power compute unit, one or more base jobs associated with the first class of jobs;
responsive to determining that one or more base jobs of the plurality of base jobs are associated with the second class of jobs, performing, by the higher-power compute unit, one or more base jobs associated with the second class of jobs; and
responsive to determining that one or more base jobs of the plurality of base jobs are associated with the third class of jobs:
transmitting, by the lower-power compute unit, one or more base jobs associated with the third class of jobs to the companion device; and
receiving, from the companion device, one or more results, the one or more results based on performing the one or more base jobs associated with the third class of jobs.

8. The method of claim 1, wherein:
the job is received via an application programming interface function call, the application programming interface function call including destination instructions; and
determining if the job is associated with the first class of jobs, the second class of jobs, or the third class of jobs is based on the destination instructions.

9. A computing system comprising:
one or more processors; and
one or more storage devices storing instructions that, when executed by the one or more processors, cause the one or more processors to:
receive a job;
determine if the job is associated with a first class of jobs, a second class of jobs, or a third class of jobs;
responsive to determining that the job is associated with the first class of jobs, perform, by a lower-power compute unit of the one or more processors, the job;
responsive to determining that the job is associated with the second class of jobs, perform, by a higher-power compute unit of the one or more processors, the job; and
responsive to determining that the job is associated with the third class of jobs:
transmit the job to a companion device; and
receive a result, the result based on performing the job.

10. The computing system of claim 9, wherein performing the job by the lower-power compute unit, transmitting the job to the companion device, and receiving the result occur while the higher-power compute unit is in a sleep state.

11. The computing system of claim 9, wherein determining if the job is associated with the first class of jobs, the second class of jobs, or the third class of jobs is based on one or more classification factors associated with the job, the classification factors including time complexity, space complexity, input size, power consumption, and specialized operation specification.

12. The computing system of claim 9, wherein determining if the job is associated with the first class of jobs, the second class of jobs, or the third class of jobs is based on one or more of a battery state, thermal state, utilization state, or hardware topology of the computing system.

13. The computing system of claim 9, wherein the higher-power compute unit is an application processor and the lower-power compute unit is a microcontroller unit, the application processor using a different operating system than the microcontroller unit.

14. The computing system of claim 9, wherein:
determining if the job is associated with the first class of jobs, the second class of jobs, or the third class of jobs is based on a service repository accessible to the lower-power compute unit, the service repository including a set of services, a location of each service of the set of services, and transmission instructions for jobs associated with the first class of jobs, the second class of jobs, or the third class of jobs; and
the lower-power compute unit transmits jobs based on the transmission instructions.

15. The computing system of claim 14, wherein the instructions further cause the one or more processors to:
determine a plurality of base jobs by comparing the job to a set of documented jobs stored at the service repository, each documented job associated with one or more respective base jobs;
determine, for each base job of the plurality of base jobs, if the respective base job is associated with the first class of jobs, the second class of jobs, or the third class of jobs;
responsive to determining that one or more base jobs of the plurality of base jobs are associated with the first class of jobs, perform, by the lower-power compute unit, one or more base jobs associated with the first class of jobs;
responsive to determining that one or more base jobs of the plurality of base jobs are associated with the second class of jobs, perform, by the higher-power compute unit, one or more base jobs associated with the second class of jobs; and
responsive to determining that one or more base jobs of the plurality of base jobs are associated with the third class of jobs:
transmit one or more base jobs associated with the third class of jobs to the companion device; and
receive one or more results, the one or more results based on performing the one or more base jobs associated with the third class of jobs.

16. The computing system of claim 9, wherein:
the job is received via an application programming interface function call, the application programming interface function call including destination instructions; and
determining if the job is associated with the first class of jobs, the second class of jobs, or the third class of jobs is based on the destination instructions.

17. A non-transitory computer-readable storage medium comprising instructions, that when executed by one or more processors of a computing system, cause the one or more processors to:
receive a job;
determine if the job is associated with a first class of jobs, a second class of jobs, or a third class of jobs;
responsive to determining that the job is associated with the first class of jobs, perform, by a lower-power compute unit of the one or more processors, the job;
responsive to determining that the job is associated with the second class of jobs, perform, by a higher-power compute unit of the one or more processors, the job; and
responsive to determining that the job is associated with the third class of jobs:
transmit the job to a companion device; and
transmit a result, the result based on performing the job.

18. The non-transitory computer-readable storage medium of claim 17, wherein:
determining if the job is associated with the first class of jobs, the second class of jobs, or the third class of jobs is based on a service repository accessible to the lower-power compute unit, the service repository including a set of services, a location of each service of the set of services, and transmission instructions for jobs associated with the first class of jobs, the second class of jobs, or the third class of jobs; and
the lower-power compute unit transmits jobs based on the transmission instructions.

19. The non-transitory computer-readable storage medium of claim 18, wherein the one or more processors further execute the instructions to:
determine a plurality of base jobs by comparing the job to a set of documented jobs stored at the service repository, each documented job associated with one or more respective base jobs;
determine, for each base job of the plurality of base jobs, if the respective base job is associated with the first class of jobs, the second class of jobs, or the third class of jobs;
responsive to determining that one or more base jobs of the plurality of base jobs are associated with the first class of jobs, perform, by the lower-power compute unit, one or more base jobs associated with the first class of jobs;
responsive to determining that one or more base jobs of the plurality of base jobs are associated with the second class of jobs, perform, by the higher-power compute unit, one or more base jobs associated with the second class of jobs; and
responsive to determining that one or more base jobs of the plurality of base jobs are associated with the third class of jobs:
transmit one or more base jobs associated with the third class of jobs to the companion device; and
receive one or more results, the one or more results based on performing the one or more base jobs associated with the third class of jobs.

20. The non-transitory computer-readable storage medium of claim 17, wherein:
the job is received via an application programming interface function call, the application programming interface function call including destination instructions; and
determining if the job is associated with the first class of jobs, the second class of jobs, or the third class of jobs is based on the destination instructions.
